(19) United States
(12) Patent Application Publication
(10) Pub. No.: US 2024/0284195 A1
(43) Pub. Date: Aug. 22, 2024

(54) BEAM INDICATION METHOD, APPARATUS AND SYSTEM FOR REPEATER

(71) Applicant: FUJITSU LIMITED, Kawasaki-shi Kanagawa (JP)

(72) Inventors: Lei ZHANG, Beijing (CN); Zhe CHEN, Beijing (CN); Qinyan JIANG, Beijing (CN)

(73) Assignee: FUJITSU LIMITED, Kawasaki-shi Kanagawa (JP)

(21) Appl. No.: 18/587,788

(22) Filed: Feb. 26, 2024

Related U.S. Application Data
(63) Continuation of application No. PCT/CN2022/113774, filed on Aug. 19, 2022.

(30) Foreign Application Priority Data
Aug. 29, 2021 (WO) PCT/CN2021/115190

(51) Int. Cl. H04W 16/28; H04W 72/1273; H04W 72/231; H04W 76/20

(52) U.S. Cl. CPC H04W 16/28; H04W 72/1273; H04W 72/231; H04W 76/20

(57) ABSTRACT

A beam indicating apparatus for a repeater, configured in a network device, includes: a transmitter configured to transmit a first indication to the repeater, the first indication being used to indicate at least one beam, wherein the at least one beam includes a first beam and/or a second beam, the first beam being used by the repeater to forward a first signal from the network device to a terminal equipment, the second beam being used by the repeater to receive a second signal from the terminal equipment, the second signal being used for being forwarded to the network device, the first beam and the second beam are denoted by beam indices.

### CROSS-REFERENCE TO RELATED APPLICATION

This application is a continuation of International Application No. PCT/CN2022/113774, filed on Aug. 19, 2022, which claims priority of International Patent Application PCT/CN2021/115190 filed on Aug. 29, 2021, the entire contents of each are incorporated herein by reference.

### FIELD

This disclosure relates to the field of communications.

### BACKGROUND

Compared with traditional 3G (third generation mobile communication technology) and 4G (fourth generation mobile communication technology) systems, a 5G (fifth generation mobile communication technology) system is able to provide larger bandwidths and higher data rates, and is able to support more types of terminals and vertical industry services. For this reason, an existing deployment frequency of a 5G system is usually higher than those of 3G and 4G systems. For example, a 5G system may be deployed in a millimeter waveband.

However, the higher a carrier frequency, the more severe a fading experienced by signals during transmission. Therefore, in actual deployment of a 5G system, especially in the millimeter waveband, how to better enhance cell coverage has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) repeater to amplify and forward communication signals between a terminal and a base station is a commonly used deployment method. RF repeaters are widely used in actual deployment of 3G and 4G systems. Generally speaking, a traditional RF repeater is a device that amplifies and forwards signals between a base station and a terminal in the RF domain. A traditional RF repeater does not demodulate or decode a forwarded signal during a forwarding process. An antenna direction of traditional RF repeater is usually fixed. The antenna direction of the traditional RF repeater is usually manually set and adjusted during initial installation, so that an antenna at the base station side points towards an incoming wave direction of the base station, and an antenna at the terminal side points towards a location that needs to be enhanced deployment. During the operation of the traditional RF repeater, the antenna direction remains unchanged. Furthermore, the traditional RF repeater does not have communication functions and is unable to perform information exchange with the base station. Hence, it does not support being configured by the base station adaptively and/or relatively dynamically.

Compared to 3G and 4G systems, the 5G system deployed at higher frequency bands and millimeter wave frequency bands adopts more advanced and complex MIMO (multiple-input multiple-output) technology. In the 5G system, a directed antenna becomes a basic component of the base station and the terminal equipment, and transmitting and receiving signals based on a beamforming technology is a basic signal transmission mode in the 5G system. Especially, characteristics of high frequency and small wavelength of the millimeter waveband are more conducive to setting up antenna panels containing relatively more elements in the base station and terminal equipment. An increase in the number of antenna elements is helpful for more accurate beamforming, making it easier to form narrow beams. Narrow beam energy convergence is helpful for enhancing signals while reducing interference with other devices. On the other hand, as narrow beams direct accurately, requirements on channel measurement and beam management are very high. Therefore, the 5G system supports relatively complex but accurate channel measurement, antenna calibration and beam management schemes, and the base station may effectively and accurately control reception beams and transmission beams of the terminal equipment through these schemes, so as to achieve better communication effects.

It was found by the inventors that use of an RF repeater for coverage enhancement is one of feasible solutions to address the coverage problem encountered in deployment of a 5G system. However, an antenna direction of a traditional RF repeater is unable to be dynamically adjusted and beams thereof are relatively wide. Although such type of RF repeater configured in a 5G system is helpful for enhancing signal strengths, it may also impose significant interference to surrounding base stations or terminal equipments due to that the transmission beams are relatively wide, thereby reducing throughput of the entire network due to increase of new interference.

In the discussion of 3GPP (3rd Generation Partnership Project) Release 18, a new type of repeater device was envisioned. In the device concept, the repeater is capable of communicating with a gNB. The gNB is able to configure the repeater to some extent, and optimize a forwarding performance of the repeater and reduce interference with other surrounding devices through these configurations.

Embodiments of this disclosure provides a beam indicating method and apparatus for a repeater and a system, wherein a network device (gNB) may configure beams used by the repeater, so as to more accurately manage forwarding of the repeater, achieve better coverage, reduce interference with surrounding devices, and improve transmission efficiency of the entire network.

According to an aspect of the embodiments of this disclosure, there is provided a beam indicating apparatus for a repeater, configured in a network device, wherein the apparatus includes:
a transmitting unit configured to transmit a first indication to the repeater, the first indication being used to indicate at least one beam.

According to another aspect of the embodiments of this disclosure, there is provided a beam determination apparatus, configured in a repeater, wherein the apparatus includes:
a receiving unit configured to receive a first indication transmitted by a network device, the first indication being used to indicate at least one beam.

One of the advantages of the embodiments of this disclosure exists in that the network device may configure beams used by the repeater, so as to more accurately manage forwarding of the repeater, achieve better coverage, reduce interference with surrounding devices, and improve transmission efficiency of the entire network.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings.

FIG. 1 is schematic diagram of an application scenario of an embodiment of this disclosure;

FIG. 2 is a schematic diagram of the beam indicating method for a repeater of an embodiment of this disclosure;

FIGS. 3-6 are schematic diagrams of some implementation scenarios of beams indicated by a network device;

FIGS. 7-31 are schematic diagrams of scenarios of usage time of beams indicated by the network device in a first time period;

FIG. 32 is a schematic diagram of the beam determination method of an embodiment of this disclosure;

FIG. 33 is a schematic diagram of the beam indicating apparatus for a repeater of an embodiment of this disclosure;

FIG. 34 is a schematic diagram of the beam determination apparatus of an embodiment of this disclosure;

FIG. 35 is a schematic diagram of the network device of an embodiment of this disclosure; and

FIG. 36 is a schematic diagram of the repeater of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

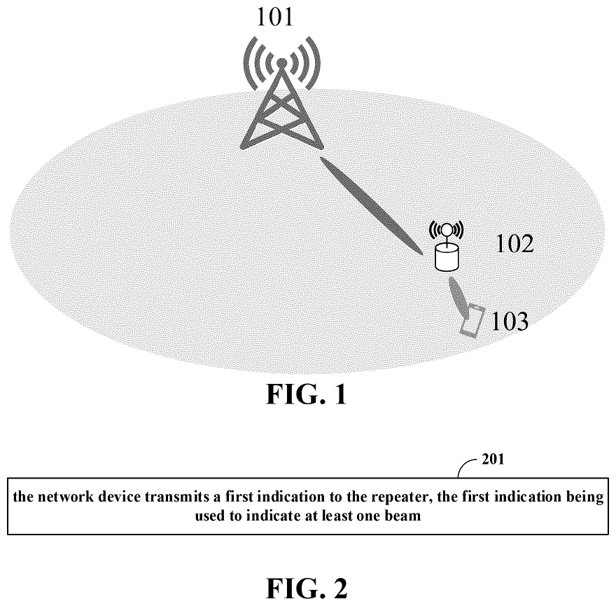

FIG. 1 is schematic diagram of an application scenario of an embodiment of this disclosure. As shown in FIG. 1, for the sake of description, the description shall be given by taking a 5G base station (gNB), a repeater and a terminal equipment (UE); however, this disclosure is not limited thereto.

In the embodiment of this disclosure, existing traffics or traffics that may be implemented in the future may be performed between the 5G base station and the terminal equipment. For example, such traffics may include but not limited to enhanced mobile broadband (eMBB), massive machine type communication (mMTC), ultra-reliable and low-latency communication (URLLC), and vehicle to everything (V2X) communication, etc.

Various implementations of the embodiments of this disclosure shall be described below with reference to the accompanying drawings. These implementations are illustrative only, and are not intended to limit this disclosure.

### Embodiment of a First Aspect

The embodiment of this disclosure provides a beam indicating method for a repeater, which shall be described from a side of a network device.

FIG. 2 is a schematic diagram of the beam indicating method for a repeater of the embodiment of this disclosure. Referring to FIG. 2, the method includes:

201: the network device transmits a first indication to the repeater, the first indication being used to indicate at least one beam.

According to the embodiment of this disclosure, the network device may configure beams used by the repeater, so as to more accurately manage forwarding of the repeater, achieve better coverage, reduce interference with surrounding devices, and improve transmission efficiency of the entire network.

In the embodiment of this disclosure, the beam may also be expressed as a reference signal (RS), a transmission configuration indication (TCI), or a spatial domain filter, etc., or may be expressed as a beam index, a reference signal index, a transmission configuration indication index, or a spatial domain filter index, etc. The above reference signal is, for example, a CSI-RS, or an SRS, or an RS for use by the repeater, or an RS transmitted by the repeater, etc. And the above TCI may also be expressed as a TCI state.

In the embodiment of this disclosure, the at least one beam is used by the repeater for forwarding signals between the network device and the terminal equipment.

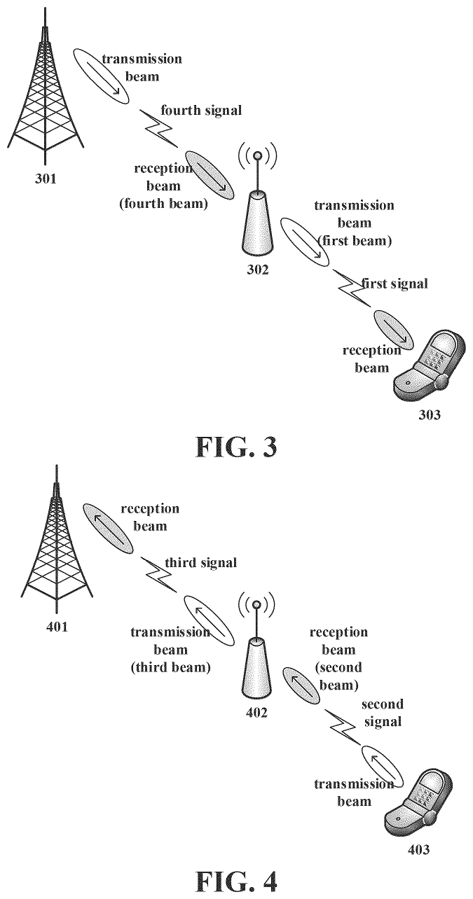

For example, one of the at least one beam is a first beam used for forwarding a first signal by the repeater from the network device to the terminal equipment. As shown in FIG. 3, the repeater 302 transmits the first signal to the terminal equipment 303 by using the first beam, the first signal being from the network device 301, such as from a fourth signal transmitted by the network device 301.

For another example, one of the at least one beam is a fourth beam used for receiving a fourth signal by the repeater from the network device, the fourth signal being used for being forwarded to the terminal equipment. As shown in FIG. 3, the repeater 302 receives the fourth signal by using the fourth beam, the fourth signal being a signal transmitted by the network device 301.

In the above example, the fourth signal includes a signal transmitted by the network device to the terminal equipment, and the repeater does not demodulate and/or decode the signal transmitted by the network device to the terminal equipment.

In this example, the signal transmitted by the network device to the terminal equipment includes at least one of signaling, data, and a reference signal.

In this example, besides the signal transmitted by the network device to the terminal equipment, the fourth signal may further include a signal transmitted by the network device to the repeater. The repeater demodulates and/or decodes the signal contained in the fourth signal for itself, and does not demodulate and/or decode the signal transmitted by the network device to the terminal equipment contained in the fourth signal.

In the above example, the first signal from the network device may be generated by the repeater by at least amplifying the fourth signal it receives.

For a further example, one of the at least one beam is a second beam used for receiving a second signal by the repeater from the terminal equipment, the second signal being used for being forwarded to the network device. As shown in FIG. 4, the repeater 402 receives the second signal by using the second beam, the second signal being a signal transmitted by the terminal equipment 403.

For still another example, one of the at least one beam is a third beam used for forwarding a third signal by the repeater from the terminal equipment to the network device. As shown in FIG. 4, the repeater 402 transmits the third signal to the network device 401 by using the third beam, the third signal being from the terminal equipment 403, such as from a second signal transmitted by the terminal equipment.

In the above example, the second signal includes a signal transmitted by the terminal equipment to the network device, and the repeater does not demodulate and/or decode the signal transmitted by the terminal equipment to the network device.

In this example, the signal transmitted by the terminal equipment to the network device includes at least one of signaling, data, and a reference signal.

In the above example, the third signal from the terminal equipment may be generated by the repeater by at least amplifying the second signal it receives.

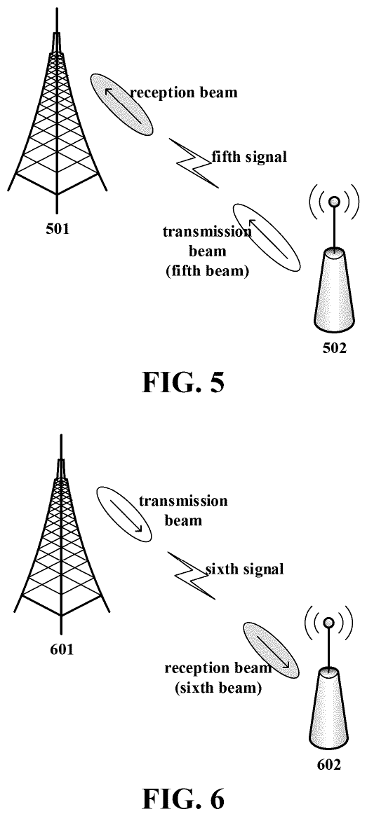

For yet another example, one of the at least one beam is a fifth beam used for transmitting a fifth signal by the repeater to the network device. As shown in FIG. 5, the repeater 502 transmits the fifth signal to the network device 501 by using the fifth beam.

For yet still another example, one of the at least one beam is a sixth beam used for receiving a sixth signal by the repeater from the network device. As shown in FIG. 6, the repeater 602 receives the sixth signal by using the sixth beam, the sixth signal being a signal transmitted by the network device 601.

In the embodiment of this disclosure, the network device may be a network device of a serving cell of the terminal equipment, or a network device of a cell in which the repeater is located, or a network device of a serving cell of the repeater, or a parent node of the repeater. A name of the repeater is not limited in this disclosure, and all devices capable of implementing the above functions are covered in the scope of the repeater in this disclosure.

In the embodiment of this disclosure, the first indication may be carried by a first PDSCH (physical downlink shared channel).

In the above embodiment, the network device may further transmit a second indication to the repeater, the second indication being used to indicate the repeater to receive the first PDSCH by using a seventh beam, so as to obtain the first indication, and perform the above processing according to the first indication.

In the above embodiment, the first indication may be MAC (media access control) layer signaling, or RRC (radio resource control) signaling, and this disclosure is not limited thereto.

In the embodiment of this disclosure, the first indication may also be indicated by a first PDCCH (physical downlink control channel).

In the above embodiment, the network device may further transmit a third indication to the repeater, the third indication being used to indicate the repeater to receive the first PDCCH by using an eighth beam, so as to obtain the first indication, and perform the above processing according to the first indication.

In the above embodiment, the first PDCCH is further used to indicate the repeater to uses a ninth beam to receive a second PDSCH transmitted by the network device to the repeater, or the first PDCCH is further used to indicate the repeater to uses a tenth beam to transmit a second PUSCH to the network device. Reference may be made to relevant techniques for contents of the first PDCCH, which shall not be repeated herein any further.

According to the embodiment of this disclosure, the network device may more quickly and accurately adjust the first beam to the sixth beam of the repeater by indicating the first indication by using the PDCCH channel, thereby effectively improving the accuracy of the beams used by the repeater, improving transmission efficiencies, and reducing spatial interference.

In addition, indicating the first beam to fourth beam by reusing the PDCCH used for scheduling the PDSCH transmission or PUSCH transmission of the repeater may lower control signaling overhead, thereby improving utilization of time-frequency resources and improving transmission efficiency of the network.

In the embodiment of this disclosure, the network device may also perform semi-static indication on the first indication by using higher-layer signaling (such as MAC or RRC signaling, etc.) or by using higher-layer signaling in combination with the PDCCH. And the network device may also indicate multiple beams in a single pass in the first indication by using higher-layer signaling (such as MAC or RRC signaling, etc.) or by using higher-layer signaling in combination with the PDCCH. In some cases, semi-statically configuring or configuring in a single pass multiple first beam to fourth beam (or first to sixth beams) for the repeater is helpful for improving the forwarding efficiency of the repeater.

It should be noted that an antenna direction of a traditional RF repeater is usually fixed. After initial installation, a wider beam at the terminal side is used for the repeater to cover its predetermined coverage area, and no further adjustment is made thereafter, or manual adjustment is needed as demanded. And the network device is unable to configure forwarding beams of the repeater.

According to the embodiment of this disclosure, the network device may configure the transmission beam, reception beam and forwarding beam of the repeater, so as to control the forwarding of the repeater by using a precise beam management scheme. The beams that are precisely managed are usually well formed and may more accurately point to the terminal equipment needing to be served. However, a well formed beam is usually narrow, making it difficult to cover the entire area that the repeater needs to cover with a well formed beam. Therefore, in order to serve for terminal equipments at different geographical positions within the coverage range of the repeater, the repeater needs to use different pointing beams at different times to serve for different terminal equipments.

In some cases, the repeater needs to communicate with the network device at different times and forward signals exchanged between the network device and the terminal equipment. The communication between the repeater and the network device may interrupt the forwarding of the repeater, in which case the network device may indicate in one time of configuration how the repeater uses the forwarding beam for a long period of time, thereby reducing communication between the repeater and the network device, improving forwarding efficiency, and improving the overall transmission efficiency of the network.

In some other cases, when a mobility of the terminal equipment served by the repeater is not obvious, the network device may also indicate in one time of configuration how the repeater uses the forwarding beam for a long period of time, thereby improving the forwarding efficiency and improving the overall transmission efficiency of the network.

Examples of configuring multiple first beam to fourth beam by the network device for the repeater shall be described below.

In the embodiment of this disclosure, at least one beam in the first beam to the fourth beam is related to a first time period, and the first time period is used by the repeater to forward signals between the network device and terminal equipment by using at least one beam in the first beam to the fourth beam within at least a part of the first time period.

In the above embodiment, the first time period may consist of at least one time unit. The time unit may be a symbol, a slot, a subframe, a mini-slot, a minimum scheduling time unit to which non-slot-based scheduling corresponds, and a frame, etc.

In the above embodiment, the first time period may be indicated by the first indication, or may be indicated by a fourth indication, or may be indicated jointly by the first indication and the fourth indication, or may be predefined in standards and preset in the repeater ex-works.

For example, a length and starting point of the first time period are indicated by the first indication, or the length and starting point of the first time period are indicated by the fourth indication, or the length of the first time period is indicated by the first indication, and the starting point of the first time period is indicated by the fourth indication, or the starting point of the first time period is indicated by the first indication, and the length of the first time period is indicated by the fourth indication, and so on.

In the above example, the length of the first time period may be the number of time units, such as the number of symbols and/or slots, or may also be an absolute time length, such as n milliseconds or n nanoseconds; where, n is greater than or equal to 0 or n is greater than 0, and n may be an integer or a decimal; however, this disclosure is not limited thereto.

In addition, in the above example, the starting point, i.e. a starting position, of the first time period, may be an index of a starting time unit, or an offset relative to a time reference point. The time reference point here may be related to the first indication or fourth indication. For example, the time reference point is a time unit in which the first indication or the fourth indication is located, and if the located time unit is more than one time unit, the time reference point may be a foremost time unit in the located time units or a rearmost time unit in the located time units, etc. In addition, the time reference point may also be specified in communication standards.

Furthermore, in the above example, the first time period may also be indicated by indicating a time unit index, such as indicating a list of time units included in the first time period; however, this disclosure is not limited thereto.

Moreover, in the above example, the fourth indication may be dynamic signaling or semi-static signaling. The dynamic signaling may be carried by a PDCCH, and the semi-static signaling may be carried by an MAC CE or RRC.

For another example, multiple combinations of at least one beam in the first beam to the fourth beam and the first time period are indicated by the fourth indication, and then one or more combinations thereof are indicated by the first indication. Here, the first indication may indicate via indices, etc., or may indicate via bitmaps, etc.

In the above embodiment, the fourth indication is transmitted by the network device to the repeater, and may be carried by a third PDSCH, or may be indicated by a third PDCCH.

In the above embodiment, for a time that does not correspond to at least one beam in the first beam to the fourth beam within the first time period, i.e. a time outside a sum of usage time in the first time period of at least one beam in the first beam to the fourth beam, the repeater does not forward signals between the network device and the terminal equipment.

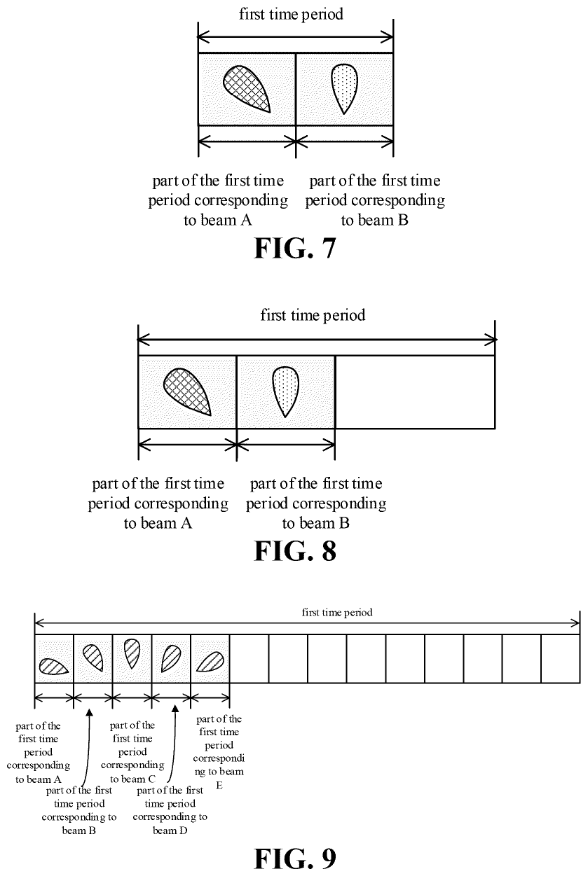

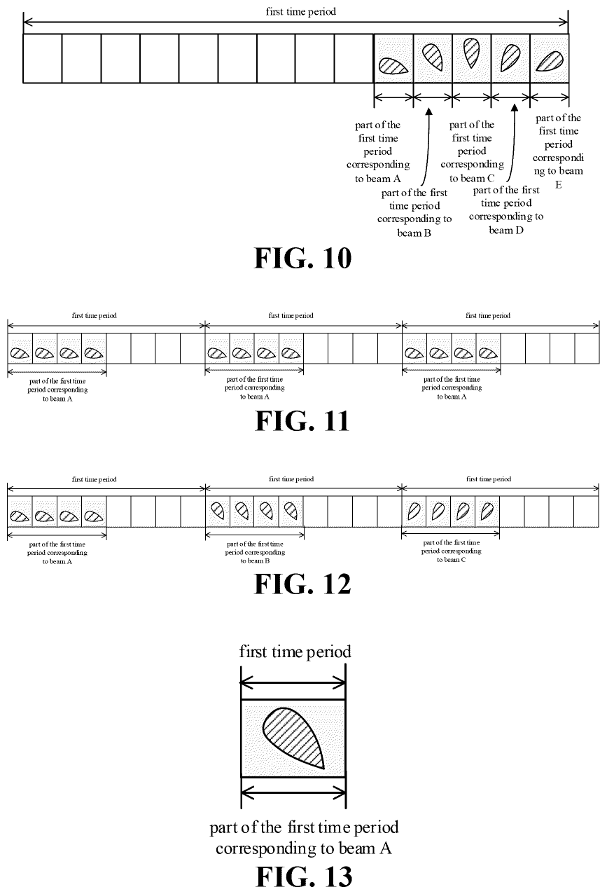

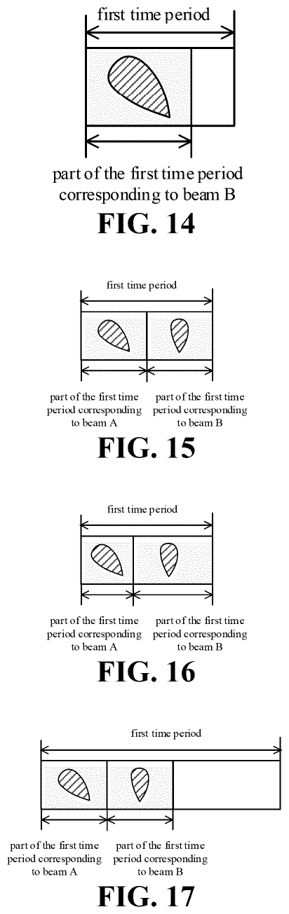

FIGS. 7 to 31 show examples of configuring multiple first beam to fourth beam by the network device for the repeater.

FIG. 7 is a schematic diagram of configuring the repeater by the network device to forward signals between the network device and the terminal equipment by using beam A and beam B in the entire first time period. Functions of beam A and beam B are different; for example, beam A is the first beam and beam B is the second beam, or beam A is the third beam and beam B is the fourth beam, and so on. Behaviors of the repeater has been explained above in detail, and shall not be repeated herein any further.

FIG. 8 is a schematic diagram of configuring the repeater by the network device to forward signals between the network device and the terminal equipment by using beam A and beam B in a part of the first time period. Functions of beam A and beam B are different; for example, beam A is the first beam and beam B is the second beam, or beam A is the third beam and beam B is the fourth beam, and so on.

FIGS. 9 and 10 show a case where the network device configures the repeater to forward signals between the network device and the terminal equipment by using five beams (referred to as beam A, beam B, beam C, beam D and beam E) in a part of the first time period. Functions of the five beams are identical, i.e. one of the first beam to fourth beam. Spatial orientations of the five beams are different (or the five beams correspond to different spatial filters). The repeater may serve for terminal equipments at different geographical positions within its coverage range by using the five beams one by one at different time units.

In the examples in FIGS. 9 and 10, a time occupied by the five beams is continuous; however, this disclosure is not limited thereto. The time occupied by the five beams may also be scattered, or is partially continuous and partially scattered, or is not aligned with a starting point and ending point of the first time period, or is partially aligned with the starting point and/or ending point of the first time period.

In the embodiment of this disclosure, unless otherwise specified, “the time occupied by the beams” refers to a time indicated by the network device for the repeater to use the beams, and/or an actual time for the repeater to use the beams.

In the embodiment of this disclosure, the first time period may also be periodic. In the first time period of different periods, relative positions of the times occupied by the beams in the first time period are identical. However, this disclosure is not limited thereto, and in the first time period of different periods, the relative positions of the times occupied by the beams in the first time period may also be different. FIGS. 11 and 12 show a case where when the first time period is periodic, the network device configures the repeater to forward signals between the network device and the terminal equipment by using at least one beam in the first beam to the fourth beam in at least a part of the first time period in each period.

In the above embodiment, when the first time period is periodic, the first indication and/or the fourth indication may indicate the starting position and/or the period and/or a position in the period where the repeater uses the forwarding beam. The starting position may be an index of a starting time unit, or may be an offset relative to a time reference point. The time reference point here may be related to the first indication or the fourth indication. For example, the time reference point is a time unit where the first indication or the fourth indication is located, and if the located time unit is more than one time units, the time reference point may be a foremost time unit in the time units, or a rearmost time unit in the time units, and so on. In addition, the time reference point may also be specified in communication standards.

In the above embodiment, the first indication and/or the fourth indication may also indicate a list of time units included in the first time period in a period, such as indices of time units, which may be specified in communication standards, such as time slots with indices of 1, 3 and 5 in a period. However, this disclosure is not limited thereto, and the indices of the time units may also be indices of the time units in a period, such as a first, third and fifth slots in a period.

In the example in FIG. 11, in the first time period of different periods, the repeater forwards the signal from the network device to the terminal equipment or forwards the signal from the terminal equipment to the network device by using beam A, and lengths of times occupied by beam A in the first time period of different periods are identical. In the example of FIG. 11, that the first time period consists of 8 time units and beam A occupies former four time units in the first time period in each period is taken as an example. However, this disclosure is not limited thereto, and beam A may also occupy other time units in the first time period of each period, and positions of the time units occupied by beam A in the first time period of each period may be identical or different. The time unit here may be a symbol, or a slot, or may be others, and this disclosure is not limited thereto.

In the example in FIG. 12, in the first time period of different periods, the repeater forwards the signals between the network device and the terminal equipment by using different beams (such as beam A, beam B and beam C). Functions of beam A, beam B and beam C are identical, i.e. one of the first beam to the fourth beam. Spatial orientations of the three beams are different (or the three beams correspond to different spatial filters). The repeater may serve for terminal equipments at different geographical positions within its coverage range by using the three beams one by one in different first time periods. For example, in a first, second and third first time periods, beam A, beam B and beam C are respectively used to receive the second signal from the terminal equipment, and at this moment, beam A, beam B and beam C are all the above second beam, but beam A, beam B and beam C are reception beams pointing at different directions, or in other words, they are different reception spatial filters.

Moreover, in the example in FIG. 12, in the first time period of each period, the lengths of times occupied by the beams are identical, which are all former four time units. The time unit here may be a symbol, or a slot, or may be others, which is not limited in this disclosure.

FIGS. 13 and 14 show a case where the repeater forwards signals between the network device and the terminal equipment by using one of the first beam to the fourth beam in at least a part of the first time period.

FIG. 13 is a schematic diagram of forwarding signals between the network device and the terminal equipment by the repeater by using beam A in the entire first time period. Beam A here may be any one of the above first beam to fourth beam. Behaviors of the repeater has been explained in detail above, and shall not be repeated herein any further.

FIG. 14 is a schematic diagram of forwarding signals between the network device and the terminal equipment by the repeater by using beam B in a part of the first time period. Beam B here may be any one of the above first beam to fourth beam. Behaviors of the repeater has been explained in detail above, and shall not be repeated herein any further.

FIGS. 15 to 24 show a case where the repeater forwards signals between the network device and the terminal equipment by using two of the first beam to the fourth beam (referred to as beam A and beam B) in at least a part of the first time period.

In the examples in FIGS. 15 to 20, functions of beam A and beam B are identical, that is, these two beams may be any one of the above first beam to fourth beam; for example, both of them are the first beam or both of them are the second beam, etc. In the examples in FIGS. 21 to 24, functions of beam A and beam B are different. For example, beam A is the first beam and beam B is the second beam, or beam A is the third beam and beam B is the fourth beam, and so on. Behaviors of the repeater has been explained in detail above, and shall not be repeated herein any further.

FIG. 15 is a schematic diagram of forwarding signals between the network device and the terminal equipment by the repeater by using beam A and beam B in the entire first time period. In the example in FIG. 15, usage time of the two beams in the first time period are identical.

FIG. 16 is a schematic diagram of forwarding signals between the network device and the terminal equipment by the repeater by using beam A and beam B in the entire first time period. Different from the example in FIG. 15, in the example of FIG. 16, usage time of the two beams in the first time period are different.

FIG. 17 is a schematic diagram of forwarding signals between the network device and the terminal equipment by the repeater by using beam A and beam B in a part of the first time period. Different from the example in FIG. 15, in the example in FIG. 17, the two beams do not occupy the entire times of the first time period, instead, they occupy a part of the first time period. For times in the first time period that are not occupied by the two beams, the repeater does not forward the signals between the network device and the terminal equipment. Moreover, in the example in FIG. 17, in the first time period, the time occupied by the two beams is continuous, and a starting point of the time occupied by the beams is identical to the starting point of the first time period.

In the embodiment of this disclosure, unless otherwise specified, “the time occupied by the beams” refers to a time indicated by the network device for the repeater to use the beams, and/or an actual time for the repeater to use the beams.

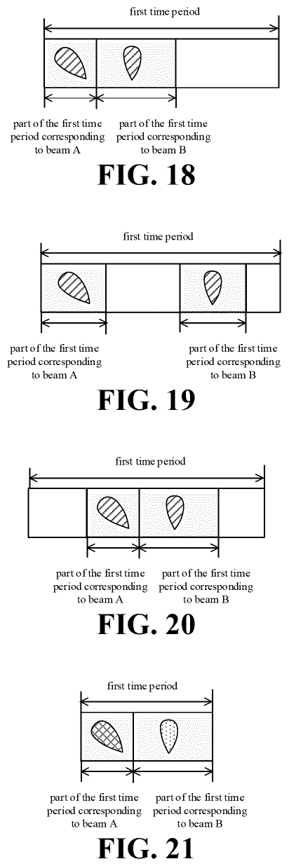

FIG. 18 is a schematic diagram of forwarding signals between the network device and the terminal equipment by the repeater by using beam A and beam B in a part of the first time period. Different from the example in FIG. 16, in the example in FIG. 18, the two beams do not occupy the entire times of the first time period, instead, they occupy a part of the first time period. For times in the first time period that are not occupied by the two beams, the repeater does not forward the signals between the network device and the terminal equipment. Moreover, in the example in FIG. 18, in the first time period, the time occupied by the two beams is continuous, and a starting point of the time occupied by the beams is identical to the starting point of the first time period.

FIG. 19 is a schematic diagram of forwarding signals between the network device and the terminal equipment by the repeater by using beam A and beam B in a part of the first time period. Different from the example in FIG. 17, in the example in FIG. 19, the time in the first time period that are occupied by the two beams is not continuous, but is scattered, that is, there exists an interval between the time occupied by the first beam and the time occupied by the second beam. A starting point of the time occupied by beam A is identical to the starting point of the first time period.

FIG. 20 is a schematic diagram of forwarding signals between the network device and the terminal equipment by the repeater by using beam A and beam B in a part of the first time period. Different from the example in FIG. 18, in the example in FIG. 20, a starting point of the time occupied by the beams is different from the starting point of the first time period.

FIG. 21 is a schematic diagram of forwarding signals between the network device and the terminal equipment by the repeater by using beam A and beam B in the entire first time period. Different from the example in FIG. 16, FIG. 21 shows a case where functions of the two beams are different.

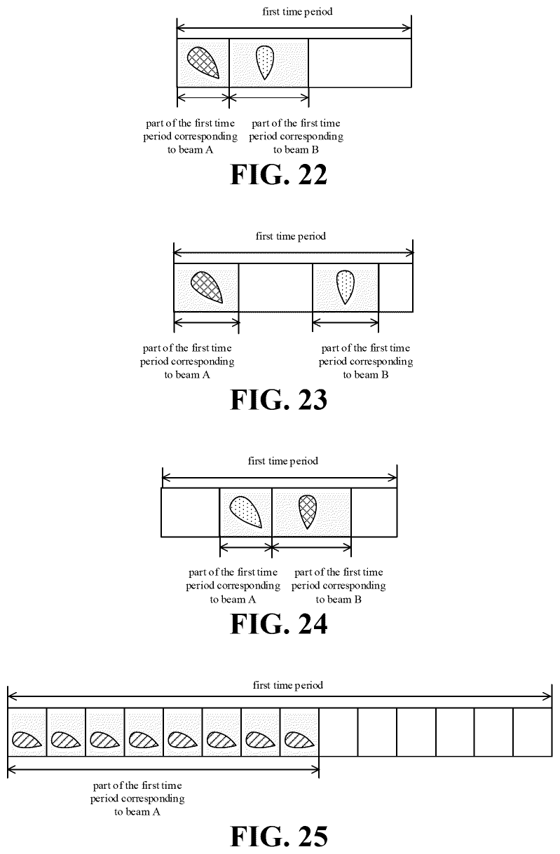

FIG. 22 is a schematic diagram of forwarding signals between the network device and the terminal equipment by the repeater by using beam A and beam B in a part of the first time period. Different from the example in FIG. 18, FIG. 22 shows a case where functions of the two beams are different.

FIG. 23 is a schematic diagram of forwarding signals between the network device and the terminal equipment by the repeater by using beam A and beam B in a part of the first time period. Different from the example in FIG. 19, FIG. 23 shows a case where functions of the two beams are different.

FIG. 24 is a schematic diagram of forwarding signals between the network device and the terminal equipment by the repeater by using beam A and beam B in a part of the first time period.

Different from the example in FIG. 20, FIG. 24 shows a case where functions of the two beams are different.

FIG. 25 shows a case where the repeater forwards signals between the network device and the terminal equipment by using one beam of the first beam to fourth beam (referred to as beam A) in a part of the first time period. In this example, the first time period consists of 14 time units, and beam A occupies former 8 time units of the 14 time units, the time units may be symbols, or slots, etc.

In the example in FIG. 25, beam A may be any one of the above first beam to fourth beam, and time units occupied by beam A are continuous. However, this disclosure is not limited thereto, and the time units occupied by beam A may also be scattered, or partially continuous and partially scattered.

In the example in FIG. 25, a starting point of the time occupied by beam A is identical to the starting point of the first time period. However, this disclosure is not limited thereto, and an ending point of the time occupied by beam A may be identical to the ending point of the first time period, or one of the time units occupied by beam A is aligned with the starting and/or ending point(s) of the first time period.

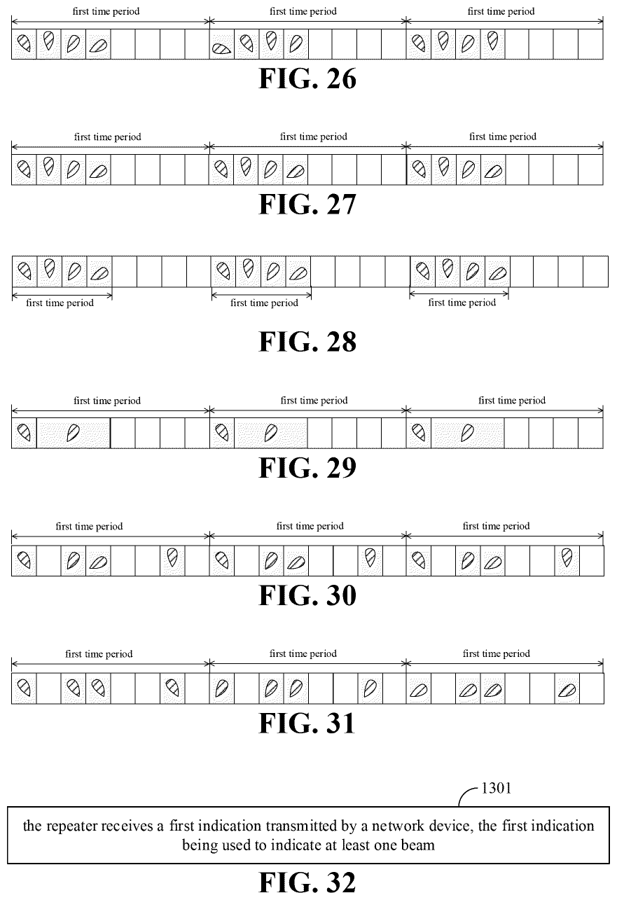

In the embodiment of this disclosure, the first time period may also be periodic. In the first time period of different periods, relative positions of the times occupied by the beams in the first time period are identical. However, this disclosure is not limited thereto, and in the first time period of different periods, the relative positions of the times occupied by the beams in the first time period may be different. FIGS. 26 to 31 show cases where the repeater forwards signals between the network device and the terminal equipment by using at least one beam of the first beam to fourth beam in at least a part of the first time period in each period when the first time period is periodic.

In the example shown in FIG. 26, in the first time period of different periods, the repeater forwards the signals between the network device and the terminal equipment by using different beams. Different from the example shown in FIG. 25, in the example shown in FIG. 26, in the first time period of each period, functions of each beam at different time intervals are different (corresponding to different first beam to fourth beam), or, their functions are identical but spatial orientations thereof are different, that is, they correspond to different spatial filters.

For example, in a first first time period, a beam at a first time interval is the fourth beam (see FIG. 3), a beam at a second time interval is the first beam (see FIG. 3), a beam at a third time interval is the second beam (see FIG. 4), and a beam at a fourth time interval is the third beam (see FIG. 4). The time unit here may be a symbol, or a slot, or may be others, and this disclosure is not limited thereto.

For another example, within the first, second and third first time periods, different beams are used to receive the second signal from the terminal equipment. The different beams are all the above second beam, but the different beams are reception beams with different orientations, or in other words, different reception spatial filters.

For a further example, in a first first time period, beams with different spatial orientations are used to receive the second signal from the terminal equipment, in a second first time period, beams with different spatial orientations are used to transmit the first signal to the terminal equipment, and in a third first time period, beams with different spatial orientations are used to receive the second signal from the terminal equipment.

In the example in FIG. 27, different from the example in FIG. 26, the repeater forwards the signals between the network device and the terminal equipment by using identical beams in the first time period of different periods. For example, the beams in the three first time periods in FIG. 27 are identical.

In the example in FIG. 28, different from the example in FIG. 27, there exists a time interval between the first time periods of different periods. A size of the time interval is not limited in this disclosure.

In the example in FIG. 29, similar to the example in FIG. 27, in the first time period of different periods, the repeater forwards the signals between the network device and the terminal equipment by using identical beams. However, different from the example in FIG. 27, in the example in FIG. 29, beams used in the first time period of each period are different.

In the example in FIG. 30, in the first time period of different periods, the repeater forwards the signals between the network device and the terminal equipment by using identical beams. However, different from the example in FIG. 27, in the example in FIG. 30, there exist time intervals between different beams in the first time period of each period.

In the example in FIG. 31, in the first time period of different periods, the repeater forwards the signals between the network device and the terminal equipment by using different beams. And there exist time intervals between different beams in the first time period of each period.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

The steps or processes related to this disclosure are only described above; however, this disclosure is not limited thereto. The method of the embodiment of this disclosure may also include other steps or processes, and reference may be made to relevant techniques for specific contents of these steps or processes.

According to the method of the embodiment of this disclosure, the network device may configure beams used by the repeater, so as to more accurately manage transmission of the repeater, achieve better coverage, reduce interference with surrounding devices, and improve transmission efficiency of the entire network.

### Embodiment of a Second Aspect

The embodiment of this disclosure provides a beam determination method, which shall be described from a side of a repeater. This method corresponds to the method of the embodiment of the first aspect, with contents identical to those in the embodiment of the first aspect being not going to be described any further.

FIG. 32 is a schematic diagram of the beam determination method of the embodiment of this disclosure. As shown in FIG. 32, the method includes:

1301: the repeater receives a first indication transmitted by a network device, the first indication being used to indicate at least one beam.

According to the embodiment of this disclosure, the network device may configure beams used by the repeater, so as to more accurately manage transmission of the repeater, achieve better coverage, reduce interference with surrounding devices, and improve transmission efficiency of the entire network.

In some embodiments, one of the at least one beam is a first beam used for forwarding a first signal by the repeater from the network device to the terminal equipment, as shown in FIG. 3.

In some embodiments, one of the at least one beam is a fourth beam used for receiving a fourth signal by the repeater from the network device, the fourth signal being used for being forwarded to the terminal equipment, as shown in FIG. 3.

In some embodiments, one of the at least one beam is a second beam used for receiving a second signal by the repeater from the terminal equipment, the second signal being used for being forwarded to the network device, as shown in FIG. 4.

In some embodiments, one of the at least one beam is a third beam used for forwarding a third signal by the repeater from the terminal equipment to the network device, as shown in FIG. 4.

In some embodiments, one of the at least one beam is a fifth beam used for transmitting a fifth signal by the repeater to the network device, as shown in FIG. 5.

In some embodiments, one of the at least one beam is a sixth beam used for receiving a sixth signal by the repeater from the network device, as shown in FIG. 6.

In some embodiments, the repeater forwards the first signal from the network device to the terminal equipment by using the first beam, as shown in FIG. 3; and/or, the repeater forwards the third signal from the terminal equipment to the network device by using the third beam, as shown in FIG. 4.

In the above embodiment, that the repeater forwards the first signal from the network device to the terminal equipment by using the first beam includes: using the fourth beam to receive the fourth signal transmitted by the network device, at least amplifying the fourth signal, generating the first signal, and using the first beam to transmit the first signal to the terminal equipment, as shown in FIG. 3. That is, the first signal from the network device may be generated by the repeater by at least amplifying the fourth signal it receives.

In the embodiment, the fourth signal may include a signal transmitted by the network device to the terminal equipment, and the repeater does not demodulate and/or decode the signal transmitted by the network device to the terminal equipment. Here, the signal transmitted by the network device to the terminal equipment includes at least one of signaling, data, and a reference signal.

In the embodiment, besides the signal transmitted by the network device to the terminal equipment, the fourth signal may further include a signal transmitted by the network device to the repeater. The repeater demodulates and/or decodes the signal contained in the fourth signal for itself, and does not demodulate and/or decode the signal transmitted by the network device to the terminal equipment contained in the fourth signal.

In the above embodiment, that the repeater forwards the third signal from the terminal equipment to the network device by using the third beam includes: using the second beam to receive the second signal transmitted by the terminal equipment, at least amplifying the second signal, generating the third signal, and using the third beam to transmit the third signal to the network device, as shown in FIG. 4. That is, the third signal from the terminal equipment may be generated by the repeater by at least amplifying the second signal it receives.

In the embodiment, the second signal may include a signal transmitted by the network device to the terminal equipment, and the repeater does not demodulate and/or decode the signal transmitted by the terminal equipment to the network device. Here, the signal transmitted by the terminal equipment to the network device includes at least one of signaling, data, and a reference signal.

In some embodiments, the repeater transmits the fifth signal to the network device by using the fifth beam, as shown in FIG. 5; and/or, the repeater uses the sixth beam to receive the sixth signal transmitted by the network device, as shown in FIG. 6.

In the embodiment of this disclosure, the network device may be a network device of a serving cell of the terminal equipment, or a network device of a cell in which the repeater is located, or a network device of a serving cell of the repeater, or a parent node of the repeater.

In the embodiment of this disclosure, the first indication may be carried by a first PDSCH (physical downlink shared channel).

In the above embodiment, the repeater may further receive a second indication transmitted the network device, the second indication being used to indicate the repeater to receive the first PDSCH by using a seventh beam, so as to obtain the first indication, and perform the above processing according to the first indication.

In the above embodiment, the first indication may be MAC (media access control) layer signaling, or RRC (radio resource control) signaling, and this disclosure is not limited thereto.

In the embodiment of this disclosure, the first indication may also be indicated by a first PDCCH (physical downlink control channel).

In the above embodiment, the repeater may further receive a third indication transmitted by the network device, the third indication being used to indicate the repeater to receive the first PDCCH by using an eighth beam, so as to obtain the first indication, and perform the above processing according to the first indication.

In the above embodiment, the first PDCCH is further used to indicate the repeater to use a ninth beam to receive a second PDSCH transmitted by the network device to the repeater, or the first PDCCH is further used to indicate the repeater to use a tenth beam to transmit a second PUSCH to the network device. Reference may be made to relevant techniques for contents of the first PDCCH, which shall not be repeated herein any further.

In the embodiment of this disclosure, examples of transmitting or forwarding the signals between the network device and the terminal equipment by the repeater according to the indications of the network device have been explained in the embodiment of the first aspect by taking FIGS. 7-26 as examples, and contents thereof are incorporated herein, which shall not be repeated herein any further.

In the embodiment of this disclosure, the repeater may be an RF repeater, an RF relay, a repeater node, a relay node, an intelligent repeater, an intelligent relay, an intelligent repeater node, and an intelligent relay node, etc. However, this disclosure is not limited thereto, and it may also be other devices.

The steps or processes related to this disclosure are only described above; however, this disclosure is not limited thereto. The method of the embodiment of this disclosure may also include other steps or processes, and reference may be made to relevant techniques for specific contents of these steps or processes.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the method of the embodiment of this disclosure, the network device may configure beams used by the repeater, so as to more accurately manage transmission of the repeater, achieve better coverage, reduce interference with surrounding devices, and improve transmission efficiency of the entire network.

### Embodiment of a Third Aspect

The embodiment of this disclosure provides a beam indicating apparatus for a repeater. The apparatus may be, for example, a network device, or may also be one or more components or assemblies configured in the network device.

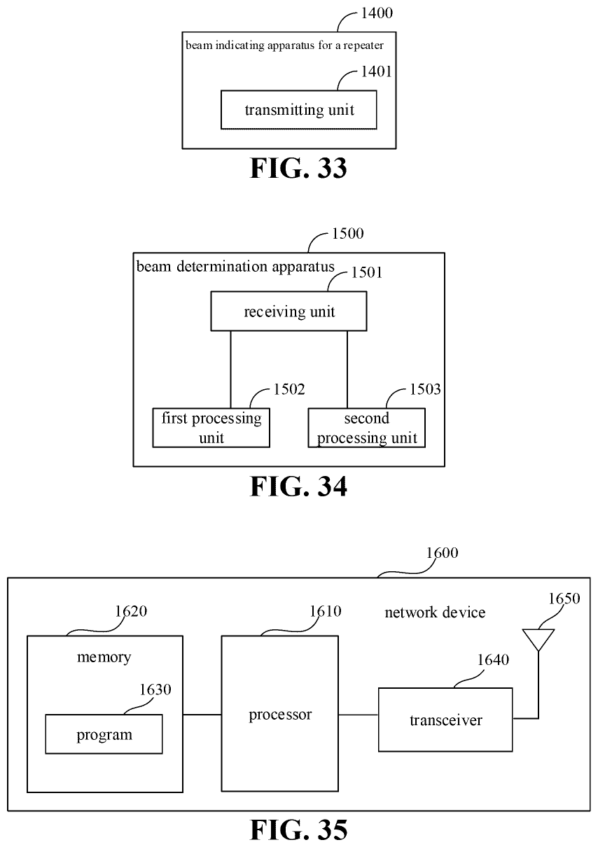

FIG. 33 is a schematic diagram of the beam indicating apparatus for a repeater of the embodiment of this disclosure. As a principle of the apparatus for solving problems is identical to that of the method in the embodiment of the first aspect, reference may be made to the implementation of the method in the embodiment of the first aspect for implementation of the apparatus, with identical contents being not going to be repeated herein any further.

As shown in FIG. 33, the beam indicating apparatus 1400 for a repeater of the embodiment of this disclosure includes:
a transmitting unit 1401 configured to transmit a first indication to the repeater, the first indication being used to indicate at least one beam.

In the embodiment of this disclosure, one of the at least one beam is:
a first beam used for forwarding a first signal by the repeater from the network device to a terminal equipment; or,
a second beam used for receiving a second signal by the repeater from the terminal equipment, the second signal being used for being forwarded to the network device; or,
a third beam used for forwarding a third signal by the repeater from the terminal equipment to the network device; or,
a fourth beam used for receiving a fourth signal by the repeater from the network device, the fourth signal being used for being forwarded to the terminal equipment; or,
a fifth beam used for transmitting a fifth signal by the repeater to the network device; or,
a sixth beam used for receiving a sixth signal by the repeater from the network device.

In some embodiments, the first signal from the network device is generated by the repeater by at least amplifying the fourth signal it receives, and the third signal from the terminal equipment is generated by the repeater by at least amplifying the second signal it receives.

In some embodiments, the network device is a network device of a serving cell of the terminal equipment.

In some embodiments, the network device is a network device of a cell in which the repeater is located.

In some embodiments, the network device is a network device of a serving cell of the repeater. In some embodiments, the network device is a parent node of the repeater.

In some embodiments, the fourth signal includes a signal transmitted by the network device to the terminal equipment, and the repeater does not demodulate and/or decode the signal transmitted by the network device to the terminal equipment.

In the above embodiments, the signal transmitted by the network device to the terminal equipment includes at least one of signaling, data, and a reference signal.

In some embodiments, the second signal includes a signal transmitted by the terminal equipment to the network device, and the repeater does not demodulate and/or decode the signal transmitted by the terminal equipment to the network device.

In the above embodiments, the signal transmitted by the terminal equipment to the network device includes at least one of signaling, data, and a reference signal.

In some embodiments, the first indication is carried by a first PDSCH.

In the above embodiments, the transmitting unit 1401 further transmits a second indication to the repeater, the second indication being used to indicate the repeater to receive the first PDSCH by using a seventh beam.

In some embodiments, the first indication is indicated by a first PDCCH.

In the above embodiments, the transmitting unit 1401 further transmits a third indication to the repeater, the third indication being used to indicate the repeater to receive the first PDCCH by using an eighth beam.

In the above embodiments, the first PDCCH is further used to indicate the repeater to use a ninth beam to receive a second PDSCH transmitted by the network device to the repeater, or the first PDCCH is further used to indicate the repeater to use a tenth beam to transmit a second PUSCH to the network device.

According to the apparatus of the embodiment of this disclosure, the network device may configure beams used by the repeater, so as to more accurately manage transmission of the repeater, achieve better coverage, reduce interference with surrounding devices, and improve transmission efficiency of the entire network.

### Embodiment of a Fourth Aspect

The embodiment of this disclosure provides a beam determination apparatus. The apparatus may be, for example, a repeater, or may also be one or more components or assemblies configured in the repeater.

FIG. 34 is a schematic diagram of the beam determination apparatus of the embodiment of this disclosure. As a principle of the apparatus for solving problems is identical to that of the method in the embodiment of the second aspect, reference may be made to the implementation of the method in the embodiment of the second aspect for implementation of the apparatus, with identical contents being not going to be repeated herein any further.

As shown in FIG. 34, the beam determination apparatus 1500 of the embodiment of this disclosure includes:
a receiving unit 1501 configured to receive a first indication transmitted by a network device, the first indication being used to indicate at least one beam.

In the embodiment of this disclosure, one of the at least one beam is:
a first beam used for forwarding a first signal by the repeater from the network device to a terminal equipment; or,
a second beam used for receiving a second signal by the repeater from the terminal equipment, the second signal being used for being forwarded to the network device; or,
a third beam used for forwarding a third signal by the repeater from the terminal equipment to the network device; or,
a fourth beam used for receiving a fourth signal by the repeater from the network device, the fourth signal being used for being forwarded to the terminal equipment; or,
a fifth beam used for transmitting a fifth signal by the repeater to the network device; or,
a sixth beam used for receiving a sixth signal by the repeater from the network device.

In some embodiments, as shown in FIG. 34, the apparatus 1500 further includes a first processing unit 1502 configured to use the first beam to forward the first signal from the network device to the terminal equipment, and/or use the third beam to forward the third signal from the terminal equipment to the network device.

In the above embodiments, the first processing unit 1502 may use the fourth beam to receive the fourth signal transmitted by the network device, at least amplify the fourth signal, generate the first signal, and use the first beam to transmit the first signal to the terminal equipment.

In the above embodiments, the first processing unit 1502 may use the second beam to receive the second signal transmitted by the terminal equipment, and the repeater at least amplifies the second signal, generates the third signal, and uses the third beam to transmit the third signal to the network device.

In some embodiments, as shown in FIG. 34, the apparatus 1500 further includes a second processing unit 1503 configured to use the fifth beam to transmit the fifth signal to the network device, and/or use the sixth beam to receive the sixth signal transmitted by the network device.

In some embodiments, the network device is a network device of a serving cell of the terminal equipment.

In some embodiments, the network device is a network device of a cell in which the repeater is located.

In some embodiments, the network device is a network device of a serving cell of the repeater.

In some embodiments, the network device is a parent node of the repeater.

In some embodiments, the fourth signal includes a signal transmitted by the network device to the terminal equipment, and the repeater does not demodulate and/or decode the signal transmitted by the network device to the terminal equipment.

In the above embodiments, the signal transmitted by the network device to the terminal equipment includes at least one of signaling, data, and a reference signal.

In some embodiments, the second signal includes a signal transmitted by the terminal equipment to the network device, and the repeater does not demodulate and/or decode the signal transmitted by the terminal equipment to the network device.

In the above embodiments, the signal transmitted by the terminal equipment to the network device includes at least one of signaling, data, and a reference signal.

In some embodiments, the first indication is carried by a first PDSCH.

In the above embodiments, the receiving unit 1501 further receives a second indication transmitted by the network device, the second indication being used to indicate the repeater to receive the first PDSCH by using a seventh beam.

In some embodiments, the first indication is indicated by a first PDCCH.

In the above embodiments, the receiving unit 1501 further receives a third indication transmitted by the network device, the third indication being used to indicate the repeater to receive the first PDCCH by using an eighth beam.

In the above embodiments, the first PDCCH is further used to indicate the repeater to use a ninth beam to receive a second PDSCH transmitted by the network device to the repeater, or the first PDCCH is further used to indicate the repeater to use a tenth beam to transmit a second PUSCH to the network device.

According to the apparatus of the embodiment of this disclosure, the network device may configure beams used by the repeater, so as to more accurately manage transmission of the repeater, achieve better coverage, reduce interference with surrounding devices, and improve transmission efficiency of the entire network.

### Embodiment of a Fifth Aspect

The embodiment of this disclosure provides a communication system. FIG. 1 is a schematic diagram of the communication system of the embodiment of this disclosure. As shown in FIG. 1, the communication system 100 includes a network device 101, a repeater 102 and a terminal equipment 103. For the sake of simplicity, description is given in FIG. 1 by taking one network device, one repeater and one terminal equipment as an example; however, this disclosure is not limited thereto.

In the embodiment of this disclosure, existing traffics or traffics that may be implemented in the future may be performed between the network device 101 and the terminal equipment 103. For example, such traffics may include but not limited to enhanced mobile broadband (eMBB), massive machine type communication (mMTC), ultra-reliable and low-latency communication (URLLC), and vehicle to everything (V2X), etc.

In the embodiment of this disclosure, the network device 101 is configured to execute the method as described in the embodiment of the first aspect, and the repeater 102 is configured to execute the method as described in the embodiment of the second aspect, the contents thereof being incorporated herein, which shall not be described herein any further.

The embodiment of this disclosure further provides a network device, which may be, for example, a base station (gNB). However, this disclosure is not limited thereto, and it may also be another network device.

FIG. 35 is a schematic diagram of a structure of the network device of the embodiment of this disclosure. As shown in FIG. 35, the network device 1600 may include a processor 1610 (such as a central processing unit (CPU)) and a memory 1620, the memory 1620 being coupled to the processor 1610. The memory 1620 may store various data, and furthermore, it may store a program 1630 for information processing, and execute the program 1630 under control of the processor 1610.

For example, the processor 1610 may be configured to execute a program to carry out the method as described in the embodiment of the first aspect. For example, the processor 1610 may be configured to perform the following control: transmitting a first indication to a repeater, the first indication being used to indicate at least one beam.

Furthermore, as shown in FIG. 35, the network device 1600 may include a transceiver 1640, and an antenna 1650, etc. Functions of the above components are similar to those in the related art, and shall not be described herein any further. It should be noted that the network device 1600 does not necessarily include all the parts shown in FIG. 35, and furthermore, the network device 1600 may include parts not shown in FIG. 35, and the related art may be referred to.

The embodiment of this disclosure further provides a repeater. The repeater may be an RF repeater, an RF relay, a repeater node, a relay node, an intelligent repeater, an intelligent relay, an intelligent repeater node, and an intelligent relay node, etc. However, this disclosure is not limited thereto, and it may also be other devices.

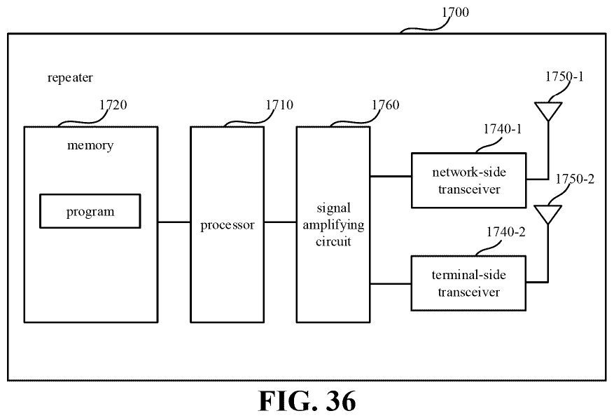

FIG. 36 is a schematic diagram of the repeater of the embodiment of this disclosure. As shown in FIG. 36, the repeater 1700 may include a processor 1710 and a memory 1720, the memory 1720 storing data and a program and being coupled to the processor 1710. It should be noted that this figure is illustrative only, and other types of structures may also be used, so as to supplement or replace this structure and achieve a telecommunications function or other functions.

For example, the processor 1710 may be configured to execute a program to carry out the method as described in the embodiment of the second aspect. For example, the processor 1710 may be configured to perform the following control: receiving a first indication transmitted by a network device, the first indication being used to indicate at least one beam.

As shown in FIG. 36, the repeater 1700 may further include a network-side transceiver 1740-1 and a network-side antenna 1750-1, a terminal-side transceiver 1740-2, a terminal-side antenna 1750-2, and a signal amplifying circuit 1760, etc.; wherein functions of the above components are similar to those in the related art, which shall not be described herein any further. It should be noted that the repeater 1700 does not necessarily include all the parts shown in FIG. 36. Furthermore, the repeater 1700 may include parts not shown in FIG. 36, and the related art may be referred to.

An embodiment of this disclosure provides a computer readable program, which, when executed in a network device, will cause a computer to carry out the method as described in the embodiment of the first aspect in the network device.

An embodiment of this disclosure provides a storage medium, storing a computer readable program, which will cause a computer to carry out the method as described in the embodiment of the first aspect in a network device.

An embodiment of this disclosure provides a computer readable program, which, when executed in a terminal equipment, will cause a computer to carry out the method as described in the embodiment of the second aspect in the repeater.

An embodiment of this disclosure provides a storage medium, storing a computer readable program, which will cause a computer to carry out the method as described in the embodiment of the second aspect in a repeater.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs a MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.
1. A beam indicating method for a repeater, wherein the method includes:
transmitting a first indication by a network device to the repeater, the first indication being used to indicate at least one beam.
2. The method according to supplement 1, wherein one of the at least one beam is:
a first beam used for forwarding a first signal by the repeater from the network device to a terminal equipment; or,
a second beam used for receiving a second signal by the repeater from the terminal equipment, the second signal being used for being forwarded to the network device; or,
a third beam used for forwarding a third signal by the repeater from the terminal equipment to the network device; or,
a fourth beam used for receiving a fourth signal by the repeater from the network device, the fourth signal being used for being forwarded to the terminal equipment; or,
a fifth beam used for transmitting a fifth signal by the repeater to the network device; or,
a sixth beam used for receiving a sixth signal by the repeater from the network device.
2A. The method according to supplement 2, wherein the first signal from the network device is generated by the repeater by at least amplifying the fourth signal it receives, and the third signal from the terminal equipment is generated by the repeater by at least amplifying the second signal it receives.
3. The method according to supplement 1, wherein the network device is a network device of a serving cell of the terminal equipment.
4. The method according to supplement 1, wherein the network device is a network device of a cell in which the repeater is located.
5. The method according to supplement 1, wherein the network device is a network device of a serving cell of the repeater.
6. The method according to supplement 1, wherein the network device is a parent node of the repeater.
7. The method according to supplement 2, wherein the fourth signal includes a signal transmitted by the network device to the terminal equipment, and the repeater does not demodulate and/or decode the signal transmitted by the network device to the terminal equipment.
8. The method according to supplement 7, wherein the signal transmitted by the network device to the terminal equipment includes at least one of signaling, data, and a reference signal.
9. The method according to supplement 2, wherein the second signal includes a signal transmitted by the terminal equipment to the network device, and the repeater does not demodulate and/or decode the signal transmitted by the terminal equipment to the network device.
10. The method according to supplement 9, wherein the signal transmitted by the terminal equipment to the network device includes at least one of signaling, data, and a reference signal.
11. The method according to any one of supplements 1-10, wherein the first indication is carried by a first PDSCH.
12. The method according to supplement 11, wherein the method further includes:
transmitting a second indication by the network device to the repeater, the second indication being used to indicate the repeater to receive the first PDSCH by using a seventh beam.
13. The method according to any one of supplements 1-10, wherein the first indication is indicated by a first PDCCH.
14. The method according to supplement 13, wherein the method further includes:
transmitting a third indication by the network device to the repeater, the third indication being used to indicate the repeater to receive the first PDCCH by using an eighth beam.
15. The method according to supplement 13, wherein the first PDCCH is further used to indicate the repeater to use a ninth beam to receive a second PDSCH transmitted by the network device to the repeater, or the first PDCCH is further used to indicate the repeater to use a tenth beam to transmit a second PUSCH to the network device.
1a. A beam determination method, wherein the method includes:
receiving, by a repeater, a first indication transmitted by a network device, the first indication being used to indicate at least one beam.
2a. The method according to supplement 1a, wherein one of the at least one beam is:
a first beam used for forwarding a first signal by the repeater from the network device to a terminal equipment; or,
a second beam used for receiving a second signal by the repeater from the terminal equipment, the second signal being used for being forwarded to the network device; or,
a third beam used for forwarding a third signal by the repeater from the terminal equipment to the network device; or,
a fourth beam used for receiving a fourth signal by the repeater from the network device, the fourth signal being used for being forwarded to the terminal equipment; or,
a fifth beam used for transmitting a fifth signal by the repeater to the network device; or,
a sixth beam used for receiving a sixth signal by the repeater from the network device.
3a. The method according to supplement 2a, wherein the method further includes:
forwarding the first signal from the network device by the repeater to the terminal equipment by using the first beam; and/or,
forwarding the third signal from the terminal equipment by the repeater to the network device by using the third beam.
4a. The method according to supplement 3a, wherein,
the forwarding the first signal from the network device by the repeater to the terminal equipment by using the first beam includes: receiving the fourth signal transmitted by the network device by using the fourth beam, at least amplifying the fourth signal, generating the first signal, and transmitting the first signal to the terminal equipment by using the first beam;
and the forwarding the third signal from the terminal equipment by the repeater to the network device by using the third beam includes: receiving the second signal transmitted by the terminal equipment by using the second beam, at least amplifying the second signal by the repeater, generating the third signal, and transmitting the third signal to the network device by using the third beam.
5a. The method according to supplement 2a, wherein the method further includes:
transmitting the fifth signal by the repeater to the network device by using the fifth beam; and/or,
transmitting the sixth signal by the repeater to the network device by using the sixth beam.
6a. The method according to supplement 1a, wherein the network device is a network device of serving cell of the terminal equipment.
7a. The method according to supplement 1a, wherein the network device is a network device of a cell in which the repeater is located.
8a. The method according to supplement 1a, wherein the network device is a network device of a serving cell of the repeater.
9a. The method according to supplement 1a, wherein the network device is a parent node of the repeater.
10a. The method according to supplement 2a, wherein the fourth signal includes a signal transmitted by the network device to the terminal equipment, and the repeater does not demodulate and/or decode the signal transmitted by the network device to the terminal equipment.
11a. The method according to supplement 10a, wherein the signal transmitted by the network device to the terminal equipment includes at least one of signaling, data, and a reference signal.
12a. The method according to supplement 2a, wherein the second signal includes a signal transmitted by the terminal equipment to the network device, and the repeater does not demodulate and/or decode the signal transmitted by the terminal equipment to the network device.
13a. The method according to supplement 12a, wherein the signal transmitted by the terminal equipment to the network device includes at least one of signaling, data, and a reference signal.
14a. The method according to any one of supplements 1a-13a, wherein the first indication is carried by a first PDSCH.
15a. The method according to supplement 14a, wherein the method further includes:
receiving, by the repeater, a second indication transmitted by the network device, the second indication being used to indicate the repeater to receive the first PDSCH by using a seventh beam.
16a. The method according to any one of supplements 1a-13a, wherein the first indication is indicated by a first PDCCH.
17a. The method according to supplement 16a, wherein the method further includes:
receiving, by the repeater, a third indication transmitted by the network device, the third indication being used to indicate the repeater to receive the first PDCCH by using an eighth beam.
18a. The method according to supplement 16a, wherein the first PDCCH is further used to indicate the repeater to use a ninth beam to receive a second PDSCH transmitted by the network device to the repeater, or the first PDCCH is further used to indicate the repeater to use a tenth beam to transmit a second PUSCH to the network device.
1b. A network device, including a memory and a processor, the memory storing a computer program, and the processor being configured to execute the computer program to carry out the method as described in any one of supplements 1-15.
1c. A repeater, including a memory and a processor, the memory storing a computer program, and the processor being configured to execute the computer program to carry out the method as described in any one of supplements 1a-18a.
1d. A communication system, including a network device and a repeater, wherein,
the network device is configured to transmit a first indication to the repeater, the first indication being used to indicate at least one beam;
and the repeater is configured to receive the first indication transmitted by the network device.

1. A beam indicating apparatus for a repeater, configured in a network device, wherein the apparatus comprises:
a transmitter configured to transmit a first indication to the repeater, the first indication being used to indicate at least one beam, wherein
the at least one beam includes a first beam and/or a second beam, the first beam being used by the repeater to forward a first signal from the network device to a terminal equipment, the second beam being used by the repeater to receive a second signal from the terminal equipment, the second signal being used for being forwarded to the network device,
the first beam and the second beam are denoted by beam indices.

2. The apparatus according to claim 1, wherein,
the first indication is used to indicate a first time period, the first time period being used by the repeater to forward the first signal by using the first beam and/or receive the second signal by using the second beam, the first time period being used by the repeater to transmit a third signal to the network device by using a third beam and/or receive a fourth signal coming from the network device by using a fourth beam.

3. The apparatus according to claim 2, wherein,
the first signal is generated by the repeater by amplifying the fourth signal, and
the third signal is generated by the repeater by amplifying the second signal.

4. The apparatus according to claim 2, wherein,
the transmitter transmits a fourth indication to the repeater,
the fourth indication being used to indicate at least one combination of the first beam and/or the second beam and the first time period, the first time period consisting of at least one time unit, the at least one time unit being a symbol and/or a slot.

5. The apparatus according to claim 4, wherein,
the fourth indication indicates a starting position and length of the first time period in the at least one combination, and
the length of the first time period being denoted by the number of symbols and/or the number of slots, and the starting position of the first time period is offset.

6. The apparatus according to claim 4, wherein,
the first indication is carried by a first PDCCH, and
the fourth indication is a semi-static indication and is carried by an RRC layer.

7. The apparatus according to claim 6, wherein,
the transmitter transmits a third indication to the repeater,
the third indication being used to indicate the repeater to receive the first PDCCH by using an eighth beam.

8. The apparatus according to claim 4, wherein
the first indication being used to indicate one or more combinations in the at least one combination of the first beam and/or the second beam and the first time period indicated by the fourth indication to the repeater.

9. The apparatus according to claim 8, wherein
the first indication is used to indicate, an index of one or more combinations in the at least one combination of the first beam and/or the second beam and the first time period indicated by the fourth indication, to the repeater.

10. The apparatus according to claim 4, wherein,
the fourth indication indicates a period of the first time period in the at least one combination,
the first indication is MAC layer signaling,
the first indication of the MAC layer signaling is carried by a first PDSCH, and
the transmitter transmits a second indication to the repeater, the second indication being used to indicate the repeater to receive the first PDSCH by using a seventh beam.

11. The apparatus according to claim 2, wherein,
the first indication is RRC layer signaling, the first indication of the RRC layer signaling indicates at least one combination of the first beam and/or the second beam and the first time period,
the first indication of the RRC layer signaling indicates a starting position, length and period of the first time period in the at least one combination, and
the length of the first time period being denoted by the number of symbols and/or the number of slots, and the starting position of the first time period is offset.

12. The apparatus according to claim 2, wherein,
the first indication is RRC layer signaling, the first indication of the RRC layer signaling is carried by a first PDSCH, and
the transmitter transmits a second indication to the repeater, the second indication being used to indicate the repeater to receive the first PDSCH by using a seventh beam.

13. The apparatus according to claim 2, wherein,
the transmitter transmits an eleventh indication to the repeater,
the eleventh indication being used to indicate at least one beam,
the at least one beam indicated by the eleventh indication being the third beam and/or the fourth beam,
the third beam and the fourth beam being denoted by TCI; and
the fourth signal received by the repeater from the network device by using the fourth beam includes a signal transmitted by the network device to the terminal equipment, and/or the third signal transmitted by the repeater to the network device by using the third beam includes a signal transmitted by the terminal equipment to the network device.

14. The apparatus according to claim 13, wherein,
the fourth signal is not used by the repeater to perform demodulation and/or decoding.

15. The apparatus according to claim 2, wherein,
the transmitter transmits a twelfth indication to the repeater,
the twelfth indication being used to indicate at least one beam,
the at least one beam indicated by the twelfth indication being the fourth beam, the fourth beam being denoted by TCI; and
the fourth signal received by the repeater from the network device at the first time period by using the fourth beam includes a signal transmitted by the transmitter to the terminal equipment and a signal transmitted by the transmitter to the repeater,
or includes only a signal transmitted by the transmitter to the terminal equipment.

16. The apparatus according to claim 15, wherein,
the signal transmitted by the transmitter to the terminal equipment contained in the fourth signal is not used by the repeater to perform demodulation and/or decoding, and
the signal transmitted to the repeater contained in the fourth signal is used by the repeater to perform demodulation and/or decoding.

17. The apparatus according to claim 1, wherein,
the network device is a network device of a serving cell of the repeater, and/or the network device is a network device of a serving cell of the terminal equipment.

18. A repeater comprising:
a receiver configured to receive a first indication coming from a network device, the first indication being used to indicate at least one beam, the at least one beam indicated by the first indication including a first beam and/or a second beam,
a transmitter configured to forward a first signal coming from the network device to a terminal equipment, wherein
the first beam being used by the transmitter to forward the first signal,
the second beam being used by the receiver to receive a second signal coming from the terminal equipment for being forwarded to the network device, and
the first beam and the second beam being denoted by beam indices.

19. The repeater according to claim 18, wherein,
the first indication is further used to indicate a first time period,
the first time period being used by the transmitter to forward the first signal by using the first beam and/or being used by the receiver to receive the second signal by using the second beam, and
the first time period is further used by the transmitter to transmit a third signal to the network device by using a third beam and/or being used by the receiver to receive a fourth signal coming from the network device by using a fourth beam.

20. The repeater according to claim 19, further comprising:
a processor configured to:
generate the first signal by amplifying the fourth signal, and
generate the third signal by amplifying the second signal.
